(19) United States
(12) Patent Application Publication
(10) Pub. No.: US 2026/0155487 A1
(43) Pub. Date: Jun. 4, 2026

(54) Low-temperature life-extension device for energy storage system adaptable to various natural cold source conditions

(71) Applicant: Leo Shucheng Sun, Charlotte, SC (US)

(72) Inventor: Yueqin Cui, Luoyang (CN)

(21) Appl. No.: 19/433,829

(22) Filed: Dec. 28, 2025

(30) Foreign Application Priority Data
Nov. 9, 2025 (CN) 2025116300803

(51) Int. Cl. H01M 10/6568; H01M 10/613; H01M 10/633; H01M 10/6569

(52) U.S. Cl. CPC H01M 10/6568; H01M 10/613; H01M 10/633; H01M 10/6569

(57) ABSTRACT

This invention relates to a low-temperature life-extension device for energy storage system adaptable to various natural cold source conditions, which is used to improve the service life of land-based or offshore energy storage systems under random conditions. The device connects to low-temperature water bodies from external natural cold sources through pipelines, utilizing the external natural cold source to directly cool the system. This reduces heat dissipation consumption, extends the equipment's service life, and saves substantial costs. The invention extends the service life of the battery modules by designing a low-temperature environment, reduces battery capacity fluctuations, and decreases long-term maintenance costs. It offers higher economic efficiency and reliability, especially suitable for new energy storage scenarios such as wind power and solar energy. In contrast, although subsea energy storage systems can also utilize external natural cold sources, their special sealing requirements, environmental conditions, and technical difficulties lead to extremely high costs.

### CROSS REFERENCE TO RELATED APPLICATIONS

This application claims the priority benefit of Chinese Patent Application No. 2025116300803, filed on 9 Nov. 2025, which itself claims the priority benefit of Chinese Patent Application No. 2024118685098, filed on 18 Dec. 2024, the entire contents of which are hereby incorporated by reference.

### TECHNICAL FIELD

The present invention belongs to the technical field related to battery life extension, and more specifically, to a low-temperature life-extension device for energy storage system adaptable to various natural cold source conditions.

### BACKGROUND OF THE INVENTION

Lithium batteries have become the core of modern energy storage solutions, widely used in electric vehicles, portable electronic devices, and other fields. However, the performance of lithium batteries is significantly affected by environmental factors, especially temperature. Low temperature is widely regarded as a major negative factor affecting battery performance, and numerous studies have explored the phenomenon of capacity loss and efficiency reduction in lithium batteries under low-temperature environments.

Existing research generally believes that low-temperature environments inhibit the electrochemical reactions in lithium batteries, reducing ion migration rates and causing capacity loss. Low temperatures not only increase internal resistance but also increase the viscosity of the electrolyte, further affecting ion conduction and ultimately reducing battery discharge efficiency. Studies show that in environments below 0° C., lithium batteries can experience a capacity loss of 15% to 30%, and at even lower temperatures, this loss may reach 40% to 60%. These phenomena are generally considered unavoidable, prompting many battery management systems to adopt insulation materials, heating devices, or preheating technologies to mitigate the negative effects of low temperatures.

To address this issue, many research and engineering solutions have focused on avoiding low-temperature environments through insulation, heating, or preheating measures. The industry primarily addresses the low-temperature issues of electric vehicle power batteries by using external heating methods. However, these heating systems have high energy consumption, long heating times, low efficiency, and poor effectiveness.

Besides, this conventional understanding overlooks the positive effects of low-temperature environments on battery lifespan. We have discovered that low-temperature environments do not shorten the battery's lifespan, but rather help to slow down the aging process of the battery, significantly extending its service life. When lithium batteries operate in low-temperature environments, the internal chemical reaction rates and aging rates slow down, thus greatly increasing the cumulative lifespan of the battery. This discovery is highly innovative and opens a new field of battery lifespan extension under low-temperature environments. It not only has theoretical breakthrough significance but also provides new directions for practical applications.

Based on this discovery, we propose a completely new energy storage system design concept: actively utilizing the lifespan extension effects generated by low-temperature environments, rather than merely passively avoiding the negative impacts of low temperatures. Traditional temperature control methods, such as heating devices, insulation materials, and preheating technologies, while effectively avoiding the negative impact of low temperatures on battery performance, are essentially designed to “avoid” low-temperature environments and maintain batteries within an ideal temperature range. In contrast, our innovative solution actively embraces low-temperature environments, utilizing the lifespan extension effects they bring, thereby significantly prolonging the cumulative service life of the battery. Our innovative discovery overturns the widespread public belief about lithium batteries operating in low-temperature environments: to avoid operating lithium batteries in low-temperature environments.

More importantly, because we have discovered that low temperatures can significantly slow down the battery aging process, thus extending the overall service life of the battery, our solution presents a new application perspective: treating low-temperature environments as a beneficial condition for optimizing battery lifespan, particularly in long-term, large-scale energy storage applications. By utilizing these natural low-temperature environments, such as subsea energy storage stations and underground energy storage stations, we can not only reduce the energy consumption of cooling and temperature control systems but also significantly extend battery lifespan, reducing the issues of battery degradation caused by high temperatures. This innovative solution fully utilizes the potential of low temperatures, effectively reducing operational costs of energy storage system, improving system safety and reliability, and lowering the risk of thermal runaway caused by high temperatures.

In the field of energy storage, traditional energy storage systems often rely on artificial cooling systems to maintain the temperature stability of the equipment, ensuring the efficient operation of battery systems. However, such cooling methods typically result in higher energy consumption and additional operational costs. In contrast, this proposal offers an innovative solution by directly or indirectly utilizing low-temperature environments from external natural cold sources, significantly reducing heat dissipation consumption and extending the service life of energy storage systems.

Overall, our research introduces a completely new lithium battery low-temperature management solution. This solution not only breaks through the conventional understanding of low-temperature negative effects but also opens up a new field for battery lifespan extension in low-temperature environments. Compared to traditional temperature control strategies, our innovative solution not only addresses the capacity loss caused by low temperatures but also actively utilizes the low-temperature environment to extend battery lifespan, providing a more economical, safe, and sustainable solution for large-scale energy storage system. This discovery is not only of great academic value but also has extensive practical application prospects, particularly in extreme environments such as subsea energy storage stations and underground energy storage stations, where the use of external natural cold sources will become a key for optimizing future energy systems. Through this innovative solution, we hope to lead a new direction in battery management in low-temperature environments, advancing technological progress and application innovation in the energy storage field.

Traditional energy storage systems usually regulate battery temperature through built-in cooling systems. Batteries are prone to overheating under high-load conditions, especially in high-temperature environments, which affects battery performance and lifespan. As a result, cooling systems often require large amounts of energy to maintain an optimal operating temperature for the battery. This energy consumption not only increases operational costs but also accelerates the aging of the batteries and cooling systems, reducing long-term system reliability.

While subsea energy storage systems also attempt to use external natural cold sources for cooling, their operation is complex and costly. Subsea energy storage systems place equipment directly in seawater and use the low temperature of seawater for cooling. Because of the high pressure of seawater, the equipment must be pressure-resistant, requiring specially designed pressure-resistant casings to ensure the safe operation of equipment in deep-sea environments. This design not only increases the complexity of the equipment but also leads to high manufacturing and maintenance costs, limiting the economic feasibility of subsea energy storage systems.

### SUMMARY OF THE INVENTION

In view of this, the invention discloses a low-temperature life-extension device for energy storage system adaptable to various natural cold source conditions, including: Energy storage cabinet module, battery modules, heat pipelines, and external natural cold sources; The energy storage cabinet module contains multiple battery modules; the battery modules are responsible for storing and releasing electrical energy and are the fundamental units and core components of the energy storage cabinet module; The heat pipelines are arranged in a winding manner between the battery modules; The heat pipelines contain circulating cooling fluid inside; The cooling fluid can exchange heat with the battery modules; The external natural cold sources include seawater, lake water, river water, groundwater, spring water, and other low-temperature water bodies, which are widespread and maintain relatively stable temperatures; The battery modules adopt passive heat dissipation designs, allowing heat transfer through the heat pipelines to exchange heat with the external natural cold sources.

It should be noted that the heat exchange discussed here is bidirectional. If the temperature of the battery modules is higher, the heat will flow from the battery modules to the cooling fluid; or if the temperature of the cooling fluid is higher, the heat will flow from the cooling fluid to the battery modules. The term “heat exchange” mentioned later also carries the same meaning.

This solution focuses on utilizing external natural cold sources (such as seawater, lake water, river water, and other low-temperature water bodies) to provide passive heat dissipation for the battery modules, thereby extending their service life. The energy storage cabinet modules contain multiple battery modules, and each battery module is responsible for storing and releasing electrical energy, making it the core unit of the energy storage system. Through the winding arrangement of the heat pipelines, the cooling fluid circulates within, exchanging heat with the battery modules, thereby effectively reducing the operating temperature of the batteries and preventing aging and performance degradation caused by overheating. The cooling fluid in the heat pipelines takes away the heat generated by the battery modules and transfers it to the external natural cold sources. The external natural cold sources provide a stable low-temperature environment, further improving the cooling efficiency.

Core Advantage 1: It adopts passive heat dissipation technology, avoiding excessive reliance on power-driven active cooling equipment, thus reducing system complexity and maintenance costs. Core Advantage 2: By introducing external natural cold sources into the energy storage station's cooling system, it significantly extends the battery modules'service life. Core Advantage 3: This solution does not require placing the energy storage station equipment on the seabed, thus avoiding the immense pressure of seawater and the need for pressure-resistant equipment, reducing the complexity and cost of equipment manufacturing. Core Advantage 4: The energy storage station can be integrated with existing systems through simple technical modifications, flexibly utilizing external low-temperature environments for cooling, reducing the costs and technical difficulties of building new facilities. Core Advantage 5: The application scenarios are not limited to subsea environments, as suitable cold sources can be selected from a wider range of geographic environments, such as seawater, lake water, river water, etc., offering strong adaptability and widespread application scenarios.

Optionally, the cooling fluid exchanges heat with the battery modules through the walls of the heat pipelines as a medium.

Optionally, the energy storage cabinet modules are equipped with an electrical control and monitoring system, which is designed to efficiently store, release, and manage electrical energy.

Optionally, the end of the heat pipelines are equipped with a heat exchanger.

Optionally, the heat exchanger at the end of the heat pipelines can be directly placed into the external natural cold source, and the heat pipelines exchanges heat with the external natural cold source through the heat exchanger. It should be noted that the heat exchange discussed here can be bidirectional.

Optionally, the battery modules exist as individual batteries, or are assembled from multiple battery cells in series or parallel, or are combined through reasonable arrangements of multiple battery units or battery packs into larger battery clusters.

This solution effectively transfers the heat generated by the battery modules to external natural cold sources, such as seawater, lake water, etc., by setting a heat exchanger at the end of the heat pipelines. This not only improves heat exchange efficiency but also avoids the consumption of additional energy. The heat exchanger comes into direct contact with the natural cold sources, enabling rapid heat dissipation and ensuring that the battery operates in a low-temperature environment, significantly extending its service life. This passive heat dissipation method reduces system complexity and operational costs, making it especially suitable for large-scale energy storage system. Furthermore, the scalable design of the battery modules allows the system to be flexibly adjusted according to demand, adapting to energy storage projects of different scales. This innovative cooling and thermal management approach can enhance the overall stability and reliability of the battery systems, especially in high-load or fast charging and discharging scenarios, effectively controlling battery temperature and preventing performance degradation or safety issues caused by overheating.

Optionally, the low-temperature life-extension device further including an internal-external heat exchange device;

Optionally, the internal-external heat exchange device serves as the overall medium for heat exchange, enabling heat transfer between the heat pipelines and the external natural cold source. It should be noted that the heat exchange discussed here can be bidirectional.

Optionally, the internal-external heat exchange device includes a cold pipeline.

Optionally, the internal-external heat exchange device includes a cold pipeline, through which the external natural cold source can flow directly (the cold pipeline can be open here).

Optionally, the cold pipeline shares the same heat exchanger with the heat pipelines, and the cold pipeline exchanges heat with the heat pipelines through the heat exchanger. It should be noted that the heat exchange discussed here can be bidirectional.

Although the cold pipeline and the heat pipelines exchange heat in the same heat exchanger, the media (cooling fluid and external natural cold source) flowing inside them do not come into direct physical contact. Heat is transferred through the walls of the heat exchanger or other separating media, ensuring isolation between the two fluids and preventing them from mixing.

The advantage and significance of this solution lie in the efficient and safe heat exchange achieved through clever structural design. The cold pipeline and heat pipelines share the same heat exchanger, utilizing the heat exchanger's separating medium to achieve bidirectional heat transfer, while maintaining physical isolation between the two media. This design effectively avoids the potential risk of mixing the cooling fluid and the external natural cold source, thereby improving the safety and reliability of the system. At the same time, the open design of the cold pipeline allows the external natural cold source to flow directly, further enhancing heat exchange efficiency, especially in conditions with large temperature differences. Additionally, the bidirectional heat exchange feature strengthens the system's adaptability under different environmental conditions, as it can be used for both cooling and heating, ensuring stable operation of the energy storage system in various climatic conditions. This efficient, flexible, and safe thermal management system significantly extends the equipment's service life, reduces maintenance costs, and is of great significance for energy conservation and emission reduction.

Optionally, the cold pipeline in the internal-external heat exchange device is equipped with a filter to remove debris or suspended particles within the cold pipeline.

Optionally, the internal-external heat exchange device includes a structure where the cold pipeline is closed and circulates heat exchange fluid.

Optionally, the structure of the internal-external heat exchange device further includes a heat exchanger; specifically, the cold pipeline shares the same heat exchanger with the heat pipelines, and the cold pipeline exchanges heat with the heat pipelines through the heat exchanger; The cold pipeline is also equipped with another heat exchanger and is directly placed in the external natural cold source, allowing the cold pipeline to exchange heat with the external natural cold source through this heat exchanger. It should be noted that the heat exchange discussed here can be bidirectional.

Optionally, the structure of the internal-external heat exchange device further includes a heat exchanger; specifically, the cold pipeline has two heat exchangers. The first heat exchanger in the cold pipeline is directly placed in the external natural cold source, and the cold pipeline exchanges heat with the external natural cold source through this heat exchanger. Another heat exchanger in the cold pipeline is connected to the heat exchanger in the heat pipelines, and the cold pipeline exchanges heat with the heat pipelines through both heat exchangers. It should be noted that the heat exchange discussed here can be bidirectional.

This solution achieves efficient multi-level heat transfer and system isolation through the innovative layout of heat exchangers and the configuration of closed cold pipeline. The cold pipeline shares a heat exchanger with the heat pipelines, using the heat exchanger's medium for heat exchange, which effectively avoids direct contact between different media, ensuring the safety and stability of the system. At the same time, by setting another heat exchanger in the cold pipeline and placing it directly in the external natural cold source, a two-level heat exchange path is constructed: one level exchanges heat with the external natural cold source through the cold pipeline, and the other level transfers heat between the cold pipeline and the heat pipelines. The closed cold pipeline design, combined with circulating heat exchange fluid, further improves the temperature control precision and heat transfer efficiency of the system.

Optionally, the cooling fluid can be pure water, organic medium, or low-temperature water body from the external natural cold source; the heat exchange fluid can also be pure water, organic medium, or low-temperature water body from the external natural cold source. The innovation lies in the system using different types of cooling and heat exchange fluids (such as pure water, organic medium, or low-temperature water body from the external natural cold source), providing flexible options for heat exchange.

Optionally, any heat exchanger can be distributed in multiple individual forms to enhance heat exchange efficiency with other heat exchangers.

Optionally, any heat exchanger can be distributed in multiple individual forms to enhance heat exchange efficiency with low-temperature water bodies.

Optionally, the heat pipelines and battery modules are equipped with small heat exchangers to enhance heat exchange between the heat pipelines and battery modules.

Optionally, the types of heat exchangers or small heat exchangers include: shell-and-tube heat exchangers, plate heat exchangers, finned heat exchangers, tube-in-tube heat exchangers, gas heat exchangers, condensers, evaporators, spiral plate heat exchangers, plate-fin heat exchangers, microchannel heat exchangers, heat pipe heat exchangers, tube heat exchangers, rotary heat exchangers, double-pipe heat exchangers, and phase-change heat exchangers.

Optionally, the shell-and-tube heat exchanger introduces hot and cold fluids on the pipe side and shell side, with heat transferred through the pipe wall. The advantage is that it can withstand high temperatures and pressures, has a robust structure, and is easy to maintain. The plate heat exchanger uses corrugated plates to form thin fluid channels for heat exchange. It has a high heat transfer efficiency and compact structure. The finned heat exchanger adds fins to the pipe surface to increase the heat transfer area, significantly improving the heat transfer efficiency of air or gas. The tube-in-tube heat exchanger exchanges heat between fluids in coaxial inner and outer tubes. It has a simple structure and low manufacturing cost. Gas heat exchangers are designed for high-temperature gases and exchange heat between gases and other media. The condenser cools steam and condenses it into liquid, releasing latent heat with high condensation efficiency. The evaporator absorbs heat from liquid to vaporize it, achieving cooling or heating with high heat transfer efficiency. Spiral plate heat exchangers use turbulent flow in spiral channels for efficient heat exchange, especially suitable for viscous fluids or liquids with suspended solids. The plate-fin heat exchanger utilizes layered structures in plates and fins for heat exchange. It is lightweight, compact, and efficient in heat transfer. Microchannel heat exchangers increase surface area and heat transfer coefficients through miniaturized channels, offering high heat transfer efficiency. Heat pipe heat exchangers use a working fluid that absorbs heat at the evaporator end and releases heat at the condenser end. The heat pipe offers rapid response and high heat transfer capabilities. Tube heat exchangers are a form of shell-and-tube heat exchanger, suitable for high-flow conditions. Rotary heat exchangers transfer heat by rotating rotors, which are suitable for continuous operation. Double-pipe heat exchangers use dual pipe walls to isolate different media and prevent leaks, improving safety. Phase-change heat exchangers use latent heat during phase transitions for heat exchange, typically applied to systems requiring efficient heat exchange and temperature regulation.

This solution showcases innovation in heat exchanger layout and structure, aiming to improve heat exchange efficiency by distributed contact, optimizing heat dissipation for the battery modules. Multiple individual heat exchangers distributed across various heat exchangers or low-temperature water bodies significantly enhance the total heat exchange area, accelerating the heat transfer process and preventing local overheating. This distributed design evenly distributes heat, reduces the occurrence of uneven heating, and improves the system's heat dissipation efficiency and stability. To further enhance heat exchange effectiveness, small heat exchangers are set between the heat pipelines and battery modules, facilitating faster heat exchange. This is especially useful during high-load or rapid charge-discharge cycles, effectively controlling the battery temperature and preventing performance degradation or safety issues due to overheating. The variety of heat exchanger types in this design is another highlight, covering shell-and-tube, plate, finned, and other structures, allowing users to choose the most appropriate type of heat exchanger based on specific application needs, achieving more efficient and flexible heat exchange. Different types of heat exchangers provide broader application scenarios, meeting cooling needs under various operational environments and enhancing system adaptability and customization.

Optionally, the types of individual batteries include lithium-based batteries, lithium-ion batteries, lithium-sulfide batteries, sodium-based accumulators, sodium-ion cells, aluminum-based storage devices, aluminum-ion storage units, metal-based batteries, graphene-based batteries, sulfur-based batteries, nickel-hydrogen batteries, lead-acid batteries, all-solid-state power sources, solid-liquid hybrid storage systems, metal-ion cells, air redox batteries, cylindrical batteries, square batteries, pouch cells, polymer cells, power storage units, halide batteries, silicon-based storage devices, supercapacitors, hybrid storage systems, intelligent battery systems, renewable energy storage devices, flow batteries, hybrid capacitors, graphene supercapacitors, modular storage devices in distributed energy systems, and other rechargeable electrical energy storage devices.

This solution further lists various types of batteries and heat exchangers as design options, aiming to provide diversified solutions for thermal management of the battery system. First, the types of batteries cover traditional lead-acid and nickel-hydrogen batteries, as well as newer lithium-based, sodium-based, and aluminum-based batteries, along with other high-tech batteries (e.g., graphene-based, sulfur-based batteries). This variety of battery options meets the diverse energy storage needs, environmental conditions, and application scenarios. Different types of batteries have varying performance characteristics, such as high energy density, long cycle life, and good safety, enabling the system to provide the best energy solution under different power demands and working environments.

Optionally, the cold pipelines and/or heat pipelines are deployed in multiple channels and connected to multiple heat exchangers or small heat exchangers to enhance heat exchange efficiency.

Optionally, the small heat exchangers are distributed in multiple individual forms to enhance heat exchange efficiency with the battery modules.

Optionally, the energy storage cabinet modules are arranged in a modular fashion, allowing the number of storage cabinet modules to be flexibly increased or decreased according to the needs, thus expanding the storage capacity.

This solution provides an approach for improving heat management efficiency and energy storage capacity through multi-channel layout and modular design. First, by using multi-channel cold pipeline and/or heat pipelines, and connecting them to multiple heat exchangers or small heat exchangers, heat exchange efficiency can be effectively enhanced. This design ensures more efficient heat conduction and dissipation, especially suitable for high-power and high-density battery systems. With multiple small heat exchangers distributed across the battery modules, the temperature of each individual battery or battery pack can be more uniformly controlled, reducing local overheating and improving the overall system stability and safety. Furthermore, the modular layout of the energy storage cabinet modules offers greater flexibility and scalability for the system. Based on actual needs, users can add or reduce the number of storage cabinets, allowing the system to adjust based on fluctuations in energy storage requirements, optimize space utilization, and enhance cost efficiency. At the same time, this design improves the scalability and adaptability of the energy storage system.

Optionally, the external natural cold sources also include underground cavities, underground mines, geothermal heat exchange layers, glaciers, permafrost layers, forest surface coverage, high-altitude cold air resources, desert night radiation cooling resources, as well as caves, wind tunnels, or air passages formed by natural terrain. These natural cold sources can be selectively used based on the geographical and climatic conditions of the energy storage station's location. Through proper heat exchange design and energy management systems, the cooling efficiency of energy storage stations can be further improved, enabling the equipment to operate in low-temperature environments and achieve energy-saving and reduced consumption goals. In this case, low-temperature water bodies can also be extended to include: low-temperature gases, low-temperature gas-liquid mixtures, low-temperature liquid fluids (e.g., liquid nitrogen, liquefied air), low-temperature solid-liquid mixtures, low-temperature solid media (e.g., ice blocks, snow layers), and other low-temperature media with cooling effects. These low-temperature media can exchange heat with the energy storage equipment through conduction, convection, or radiation.

The benefit of this design lies in introducing various natural cold sources and low-temperature media, allowing the cooling solution to be selected according to the specific conditions of the energy storage station's location. This enhances the system's flexibility and adaptability, utilizing multiple heat exchange methods such as conduction, convection, and radiation to effectively improve cooling efficiency. It also reduces the thermal stress and temperature fluctuations in equipment operation, extending the service life of critical equipment while reducing reliance on high-energy artificial cooling systems, thus achieving energy conservation and emission reduction goals. Moreover, this approach fully utilizes natural resources, aligns with ecological environmental principles, reduces construction and operational costs, and enhances the reliability and sustainability of energy storage stations under extreme climate conditions, providing robust support for optimizing overall system performance.

Optionally, the heat pipelines are made of corrosion-resistant materials, suitable for various types of heat exchange fluids.

Optionally, the cold pipelines are made of corrosion-resistant materials, suitable for various types of cooling fluids.

Optionally, the energy storage cabinet modules are made from corrosion-resistant materials, suitable for marine, high-salinity, or corrosive environments.

Optionally, the energy storage cabinet modules are placed near the external natural cold source to facilitate heat dissipation using the external natural cold source.

Optionally, the system further includes a wastewater treatment module for processing drainage generated during the cooling of low-temperature water bodies, preventing pollution or temperature anomalies from impacting the ecosystem.

Optionally, the cooling fluid in the heat pipelines dissipates heat through natural flow without the need for additional energy input.

Optionally, the heat exchange fluid in the cold pipeline dissipates heat through natural flow without the need for additional energy input.

This solution proposes adaptability improvements for special environments, using corrosion-resistant materials for the energy storage cabinet modules to enable long-term operation in marine or high-salinity environments, thus expanding the application scope. At the same time, placing the energy storage cabinet modules near the external natural cold source allows for direct cooling with low-temperature water from the external natural cold source, which not only improves cooling efficiency but also reduces the energy input requirement, achieving energy-saving goals. Additionally, the added wastewater treatment module effectively processes drainage from the cooling process, preventing potential pollution or temperature abnormalities from affecting the natural ecosystem, reflecting the sustainable development concept of the system design.

Optionally, the heat pipelines are equipped with temperature sensors and/or small pumps, which can be used to adjust the flow rate of the cooling fluid.

Optionally, the cold pipelines are equipped with temperature sensors and/or small pumps, which can be used to adjust the flow rate of the heat exchange fluid.

Optionally, the energy storage cabinet modules are also equipped with a real-time temperature control system that dynamically adjusts the flow rate or volume of the cooling fluid, maintaining the actual temperature of the battery modules at the lifetime-extending temperature T.

Optionally, the energy storage cabinet modules are also equipped with a real-time temperature control system that dynamically adjusts the flow rate or volume of the heat exchange fluid, helping maintain the actual temperature of the battery modules at the lifetime-extending temperature T.

Optionally, the real-time temperature control system can also monitor the temperatures of the cooling fluid, heat exchange fluid, individual battery modules, and individual heat exchangers, as well as the temperature differences between them, and use this information to make temperature adjustments.

This solution introduces temperature sensors and a real-time temperature control system to provide more intelligent temperature control management for the battery modules. The system monitors the temperature of the cooling fluid, heat exchange fluid, and the surface and internal temperature of the battery modules, and dynamically adjusts the flow rate or volume of the cooling fluid or heat exchange fluid to ensure that the battery modules always operate within the optimal lifespan extension temperature range. The temperature control system can also precisely control temperature differences, optimizing heat distribution and improving the system's response speed and reliability, ensuring long-term stable operation of the battery modules. For example, if the temperature of the battery modules exceeds a certain threshold, the flow rate of the cooling fluid is increased to strengthen heat exchange between the battery modules and the cooling fluid; if the temperature of the cooling fluid exceeds a certain threshold, the flow rate of the heat exchange fluid is increased to enhance heat exchange between the cooling fluid and the heat exchange fluid. Alternatively, if the temperature difference between the battery modules and cooling fluid exceeds a certain value, the flow rate of the cooling fluid is increased to strengthen heat exchange. Additionally, when the temperature of a specific battery module exceeds the threshold, the system can automatically increase the flow rate of the cooling fluid at that position, reducing thermal accumulation and maintaining the battery module in the optimal operating state. The system can also monitor environmental temperature and automatically reduce or stop the flow of the heat exchange fluid, or switch to a heating mode, to adapt to sudden temperature drops.

Optionally, the lifetime-extending temperature T refers to a temperature value. By controlling the operating temperature of the battery modules around the lifetime-extending temperature T, the cumulative service life of the battery modules can be effectively extended. The steps to determine the lifetime-extending temperature T are as follows: First, based on the typical usage scenario of the target battery, select a temperature lower than the commonly recognized optimal working temperature in the industry as the lifetime-extending temperature T. Second, based on the usage environment of the target battery, determine the expected temperature variation range and set the average temperature within this range as the lifetime-extending temperature T.

Optionally, if it is not necessary to ensure that the surface or internal temperature of the battery modules remains constantly at the lifetime-extending temperature T, the real-time temperature control system can adjust the flow rate or volume of the heat exchange fluid or cooling fluid to maintain the temperature of the battery modules within a temperature range T_range near the lifetime-extending temperature T.

This solution defines and adjusts the lifetime-extending temperature T and its range. By combining scientific calculations and practical application requirements, the optimal temperature below the recognized best working temperature is selected as the lifetime-extending temperature T, effectively extending the cumulative service life of the battery modules. The real-time temperature control system can flexibly adjust the temperature to the lifetime-extending temperature T or its nearby temperature range T_range, enabling precise temperature control based on the specific needs of the application. This temperature management mechanism significantly enhances the performance and lifespan of the energy storage system and improves its applicability in various industries.

Optionally, depending on the size, type, model, and parameters of the battery modules, the lifetime-extending temperature T can be any integer temperature between −50° C. and 50° C., or any integer temperature within a range of ±0.25° C., ±0.5° C., ±1° C. around the values between −50° C. and 50° C.

Optionally, the temperature control measures can be used to adjust the surface or internal temperature of the battery modules to a specific temperature range T_range, with the upper and lower limits of the T_range selected from one of the following values: 50° C., 45° C., 40° C., 35° C., 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C.

Optionally, T_range can be specifically set based on fixed temperature sizes, specifically, setting the temperature range to ±0.001° C., ±0.002° C., ±0.004° C., ±0.008° C., ±0.016° C., ±0.032° C., ±0.064° C., ±0.128° C., ±0.256° C., ±0.512° C., ±1° C., ±2° C., ±4° C., ±8° C., ±16° C., ±32° C., ±64° C., ±128° C., ±256° C., ±512° C. relative to the lifetime-extending temperature T.

Optionally, T_range can also be set based on percentage, specifically setting the temperature range to ±0.001%, ±0.002%, ±0.004%, ±0.008%, ±0.016%, ±0.032%, ±0.064%, ±0.128%, ±0.256%, ±0.512%, ±1%, ±2%, ±4%, ±8%, ±16%, ±32%, ±64%, ±128%, ±256%, ±512% relative to the lifetime-extending temperature T.

This solution further optimizes the definition of the lifespan extension temperature value and its range, allowing users to adjust the temperature control range according to the specific type and specification of the battery modules. The range covers specific temperature values between −50° C. and 50° C., along with fine-tuned upper and lower fluctuation intervals. Furthermore, users can select between a fixed range or a percentage-based adjustment of the temperature control scheme.

Optionally, when water quality is poor or cooling performance diminishes, alternative measures can be taken to ensure the battery modules maintain the lifetime-extending temperature T.

The solution further including alternative measures: a heat pump system. The heat pump system serves as internal-external heat exchange device for auxiliary cooling and is activated only when cooling demand is high, preventing the battery modules from overheating and causing thermal runaway, thus avoiding the continuous high-energy consumption problems seen in traditional designs. The heat pump system includes an evaporator, condenser, compressor, and expansion valve. The evaporator is connected to the internal-external heat exchange device, used to improve cooling efficiency when the cooling fluid flow is insufficient or cooling performance is poor.

Optionally, the heat pump system monitors the temperature of the battery modules or individual heat exchangers and automatically starts operating when the temperature difference exceeds a predetermined threshold, enhancing the cooling system's performance.

Optionally, the heat pump system includes an evaporator and heat pump pipeline. The evaporator is placed on the heat pump pipeline, and the evaporator is connected to the heat exchanger in the heat pipelines. Refrigerant circulates through the heat pump pipeline. The cooling fluid in the heat pipelines flows through the heat exchanger, it is cooled by the refrigerant in the evaporator. The refrigerant circulates through the heat pump pipeline to dissipate heat.

Optionally, the heat pump pipeline is sequentially connected to a compressor, condenser, expansion valve, and evaporator along the circulation direction. The evaporator is positioned between the expansion valve and compressor. The condenser uses stable low-temperature substances from the external natural cold source to carry out the condensation process, exchanging heat from the refrigerant to the external natural cold source.

Optionally, the refrigerant used can be pure water or an organic medium.

Optionally, the heat pump pipeline is equipped with a small pump, which can adjust the flow rate of the refrigerant.

Optionally, the energy storage cabinet modules are also equipped with a real-time temperature control system, the real-time temperature control system can monitor the temperature of the battery modules and dynamically adjust the flow rate or volume of the refrigerant to maintain the surface or internal temperature of the battery modules at the lifetime-extending temperature T.

Optionally, if it is not strictly necessary to ensure that the surface or internal temperature of the battery modules is always maintained at the lifetime-extending temperature T, the real-time temperature control system can adjust the flow rate or volume of the refrigerant to keep the surface or internal temperature of the battery modules within the temperature range T_range, near the lifetime-extending temperature T.

This solution introduces a heat pump system as an auxiliary cooling technology, particularly useful in extreme heat conditions or when cooling performance weakens. It effectively supplements cooling capacity. The heat pump system, through the cooperation of the evaporator, compressor, condenser, and other core components, achieves low-energy, high-efficiency cooling. The system can also dynamically monitor temperature differences in the battery modules or heat exchangers, automatically starting when the temperature difference exceeds the set threshold to ensure the cooling effect is optimal.

Optionally, the low-temperature life-extension device can be provided with phase change materials (PCM) at specific positions as required, thereby “anchoring” the temperature of specific positions within a target temperature range.

Optionally, the phase change materials can be arranged at the junctions of different components of the low-temperature life-extension device, or coated on the outer surfaces of various components of the low-temperature life-extension device, or placed inside various components of the low-temperature life-extension device.

Optionally, the melting point of the phase change materials can be precisely adjusted through alloy formulation optimization or microcapsule encapsulation technology.

Optionally, the melting point of the phase change materials can be arbitrarily selected from the following values (non-exhaustive examples) and within ±2.5° C. of these values: 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., −25° C.

By reasonably configuring the phase change materials in the low-temperature life-extension device, the invention can effectively absorb or release latent heat during the operation of the battery, thereby mitigating drastic temperature fluctuations of the battery modules, enhancing the stability and safety of battery operation, and extending the service life of the batteries.

It should be understood that the above general descriptions and the detailed descriptions later are exemplary and do not limit the disclosure.

This proposal, through innovative technical architecture, adopts a pipeline approach to utilize the external natural cold source environment. The core advantage of this solution is that it introduces cooling media from low-temperature environments and uses pipelines to deliver the cooling fluid to the energy storage system, thereby reducing the battery temperature. The greatest advantage of this design is that the energy storage system itself does not need to be placed in a low-temperature environment but can be located on land. As a result, the system does not require additional pressure-resistant casings to withstand seawater pressure, significantly reducing the complexity and cost of equipment manufacturing.

In addition, since the energy storage equipment does not need to be placed on the seabed, the implementation of this solution greatly simplifies equipment maintenance and upgrades. Traditional subsea energy storage systems often face the challenge of maintaining equipment under high-pressure conditions, and when equipment needs to be upgraded or replaced, complex subsea operations are required. In contrast, this proposal allows easy connection to the cold source via pipelines, facilitating the modification of existing equipment and reducing maintenance difficulty, enhancing the system's flexibility and adaptability.

Compared to subsea energy storage systems, this proposal significantly reduces construction costs. Subsea energy storage systems need to withstand the enormous pressure of seawater, so the cost of equipment and pressure-resistant materials is very high. To ensure the equipment operates safely for long periods, specially designed structures are needed to prevent corrosion, leakage, and other issues, which further increase maintenance and operating costs. Moreover, the technical level required for the construction and operation of subsea energy storage systems is also higher, leading to high overall costs.

In contrast, this pipeline approach proposal can transport the cooling media through land-based equipment, avoiding the pressure of the seabed environment on the equipment. With reasonable pipeline design and cooling fluid selection, it can effectively bring cold sources from external low-temperature environments into the system and achieve low-temperature cooling. Since the cooling system is separated from the energy storage equipment, the complexity of equipment production and maintenance is significantly reduced. The pipeline approach not only reduces the demand for pressure-resistant equipment but also allows the cooling system's scale to be flexibly adjusted, further reducing both initial construction and long-term operational costs.

Another notable advantage of this proposal is its excellent environmental adaptability. Low-temperature environments are widely and relatively stably distributed across different geographical areas, providing a broader selection of suitable cold sources for cooling. In contrast, subsea energy storage systems can only rely on specific marine areas and are limited by marine environmental conditions. This means that this pipeline approach has a broader application scope and can be implemented in more regions, offering greater sustainability.

Furthermore, since low-temperature environments help slow down the aging process of batteries, this proposal can further enhance the long-term economic benefits of energy storage systems. By extending the battery's lifespan, the frequency of equipment replacements can be reduced, and performance degradation caused by battery aging can be minimized, thereby lowering the system's maintenance and replacement costs.

### BRIEF DESCRIPTION OF DRAWINGS

In order to more clearly explain the technical solutions of the embodiments of the present invention, the following is a brief introduction to the accompanying drawings required for the embodiments. It is evident that the drawings described below are merely some embodiments of the present invention, and those skilled in the art may derive other drawings from these without inventive effort.

FIG. 1 is a schematic diagram of a low-temperature life-extension device for energy storage system adaptable to various natural cold source conditions according to an embodiment of the present invention.

FIG. 2 is another schematic diagram of a low-temperature life-extension device for energy storage system adaptable to various natural cold source conditions according to an embodiment of the present invention.

FIG. 3 is another schematic diagram of a low-temperature life-extension device for energy storage system adaptable to various natural cold source conditions according to an embodiment of the present invention.

FIG. 4 is another schematic diagram of a low-temperature life-extension device for energy storage system adaptable to various natural cold source conditions according to an embodiment of the present invention.

FIG. 5 is another schematic diagram of a low-temperature life-extension device for energy storage system adaptable to various natural cold source conditions according to an embodiment of the present invention.

FIG. 6 is another schematic diagram of a low-temperature life-extension device for energy storage system adaptable to various natural cold source conditions according to an embodiment of the present invention.

FIG. 7 is another schematic diagram of a low-temperature life-extension device for energy storage system adaptable to various natural cold source conditions according to an embodiment of the present invention.

FIG. 8 is another schematic diagram of a low-temperature life-extension device for energy storage system adaptable to various natural cold source conditions according to an embodiment of the present invention.

FIG. 9 is another schematic diagram of a low-temperature life-extension device for energy storage system adaptable to various natural cold source conditions according to an embodiment of the present invention.

Energy storage cabinet module 102, battery module 103, heat pipeline 104, external natural cold source 501, heat exchanger 301, heat exchanger 301A, heat exchanger 301B, heat exchanger 301X, internal-external heat exchange device 202, cold pipeline 111, filter 203, heat pump pipeline 400, evaporator 401, expansion valve 402, condenser 403, compressor 404, frame structure 805, electrical control and monitoring system 803, power line 801, distributed deployment first part of energy storage cabinet module 102(1), distributed deployment second part of energy storage cabinet module 102(2), distributed deployment third part of energy storage cabinet module 102(3).

### DETAILED DESCRIPTION OF THE INVENTION

The following will describe in detail the various exemplary embodiments of the present disclosure with reference to the accompanying drawings. The following description applies to various embodiments of the present invention, with the preferred embodiment being only one of them. The descriptions of the exemplary embodiments are illustrative only and are not intended to limit the disclosure or its applications or uses. The disclosure can be implemented in many different forms and is not limited to the embodiments described here. These embodiments are provided to make the disclosure thorough and complete and to fully convey the scope of the disclosure to those skilled in the art. It should be noted that, unless otherwise specifically stated, the relative arrangement of parts, components, and numerical values described in these embodiments should be interpreted as merely illustrative and not as limiting.

In the following description, many details are discussed to provide a more thorough explanation of the embodiments of the present invention. However, it is evident to those skilled in the art that the embodiments of the invention can be practiced without these specific details. In other embodiments, known structures and devices are shown in block diagrams instead of in detail to avoid making the embodiments of the invention difficult to understand. The present disclosure provides a low-temperature life-extension device for energy storage systems, applicable under various external natural cold sources. By directly or indirectly utilizing the low-temperature environment of external natural cooling sources, it significantly reduces heat dissipation losses and extends the service life of the energy storage system, offering great application potential.

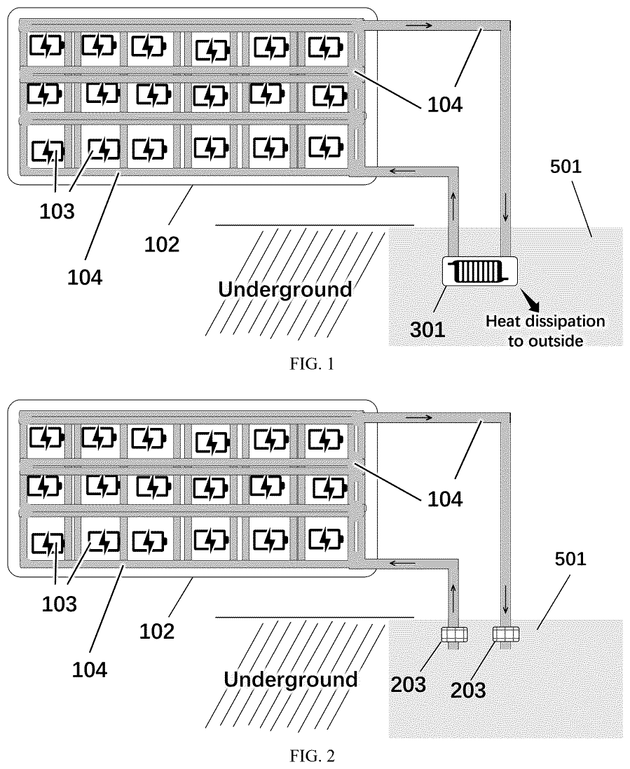

FIG. 1 is an exemplary embodiment showing a low-temperature life-extension device for energy storage system adaptable to various natural cold source conditions, including: Energy storage cabinet module 102, battery modules 103, heat pipelines 104, external natural cold sources 501.

The energy storage cabinet module 102 contains multiple battery modules 103; the battery modules 103 are responsible for storing and releasing electrical energy and are the fundamental units and core components of the energy storage cabinet module 102.

The heat pipelines 104 are arranged in a winding manner between the battery modules 103. The heat pipelines 104 contain circulating cooling fluid inside; The cooling fluid can exchange heat with the battery modules 103.

The external natural cold sources 501 include seawater, lake water, river water, groundwater, spring water, and other low-temperature water bodies, which are widespread and maintain relatively stable temperatures.

The battery modules 103 adopt passive heat dissipation designs, allowing heat transfer through the heat pipelines 104 to exchange heat with the external natural cold sources 501.

Optionally, the energy storage cabinet modules 102 are equipped with an electrical control and monitoring system, which is designed to efficiently store, release, and manage electrical energy.

The end of the heat pipelines 104 are equipped with a heat exchanger 301.

The heat exchanger 301 at the end of the heat pipelines 104 can be directly placed into the external natural cold source 501, and the heat pipelines 104 exchanges heat with the external natural cold source 501 through the heat exchanger 301.

The cooling fluid exchanges heat with the battery modules 103 through the walls of the heat pipeline 104 as a medium.

The battery modules 103 exist as individual batteries, or are assembled from multiple battery cells in series or parallel, or are combined through reasonable arrangements of multiple battery units or battery packs into larger battery clusters.

Optionally, the energy storage cabinet modules 102 are placed near the external natural cold source 501 to facilitate heat dissipation using the external natural cold source 501.

It should be noted that the low-temperature life-extension device for energy storage system adaptable to various natural cold source conditions can be deployed on land, such as by lakesides, riverbanks, or coastlines. It can also be deployed at sea, such as by constructing floating platforms to install battery storage equipment, directly applied to offshore oil drilling platforms, offshore wind power platforms, or even directly applied to large battery-powered ships. Such deployment is essentially designed to facilitate the use of external natural cold sources like seawater, lake water, river water, river water, well water, groundwater, and spring water.

FIG. 2 is another schematic diagram of the low-temperature life-extension device for energy storage system adaptable to various natural cold source conditions according to an embodiment of the present invention.

The end of the heat pipeline 104 is open, allowing the external natural cold source 501 to flow directly through it. Heat exchange occurs between the heat pipeline 104 and the battery module 103.

Optionally, the heat pipeline 104 is equipped with a filter 203 to remove debris or suspended particles inside the heat pipeline 104.

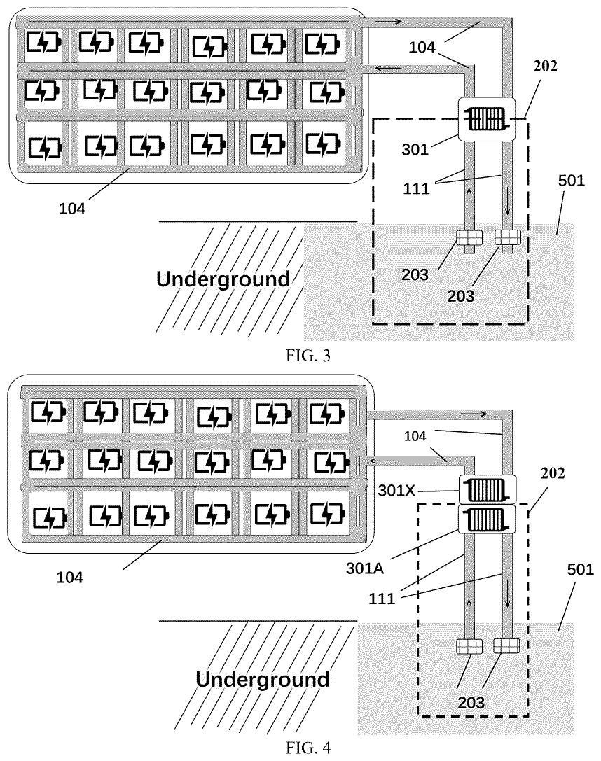

FIG. 3 is another schematic diagram of the low-temperature life-extension device for energy storage system adaptable to various natural cold source conditions according to an embodiment of the present invention.

Optionally, the low-temperature life-extension device further including an internal-external heat exchange device 202. The internal-external heat exchange device 202 and its components can be easily disassembled and replaced.

Optionally, the internal-external heat exchange device 202 serves as the overall medium for heat exchange, enabling heat transfer between the heat pipelines 104 and the external natural cold source 501.

Optionally, the internal-external heat exchange device 202 includes a cold pipeline 111. The cold pipeline 111 helps facilitate heat exchange between the heat pipeline 104 and the external natural cold source 501.

Optionally, the cold pipeline 111 in the internal-external heat exchange device 202 is open, allowing the external natural cold source 501 to flow directly through it.

The cold pipeline 111 shares the same heat exchanger 301 with the heat pipelines 104, and the cold pipeline 111 exchanges heat with the heat pipeline 104 through the heat exchanger 301.

Optionally, the cooling fluid can be pure water, organic medium, or low-temperature water body from the external natural cold source 501. The heat exchange fluid can also be pure water, organic medium, or low-temperature water body from the external natural cold source 501.

Optionally, the cold pipeline 111 in the internal-external heat exchange device 202 is equipped with a filter 203 to remove debris or suspended particles within the cold pipeline 111.

FIG. 4 is another schematic diagram of the low-temperature life-extension device for energy storage system adaptable to various natural cold source conditions according to an embodiment of the present invention.

Optionally, the internal-external heat exchange device 202 also includes a heat exchanger 301A. The heat exchanger 301A in the internal-external heat exchange device 202 directly contacts the heat exchanger 301X in the heat pipeline 104. The cold pipeline 111 exchanges heat with the heat pipeline 104 through both heat exchangers 301A and 301X.

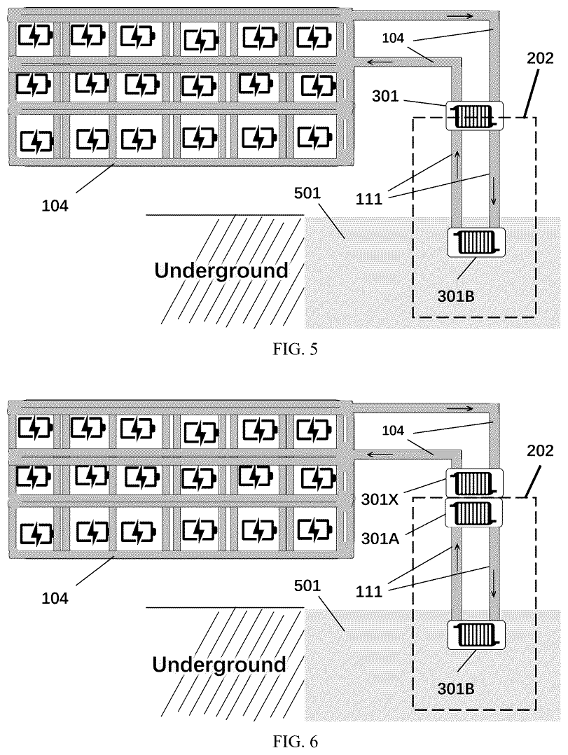

FIG. 5 is another schematic diagram of the low-temperature life-extension device for energy storage system adaptable to various natural cold source conditions according to an embodiment of the present invention.

Optionally, the internal-external heat exchange device 202 includes a structure where the cold pipeline 111 is closed and circulates heat exchange fluid. The cold pipeline 111 shares the same heat exchanger 301 with the heat pipelines 104. The cold pipeline 111 exchanges heat with the heat pipelines 104 through this heat exchanger 301. The cold pipeline 111 is also equipped with another heat exchanger 301B that is directly immersed in the external natural cold source 501. The cold pipeline 111 exchanges heat with the external natural cold source 501 through this heat exchanger 301B.

FIG. 6 is another schematic diagram of the low-temperature life-extension device for energy storage system adaptable to various natural cold source conditions according to an embodiment of the present invention.

Optionally, the internal-external heat exchange device 202 includes a structure where the cold pipeline 111 is closed and circulates heat exchange fluid. The cold pipeline 111 is equipped with two heat exchangers 301A and 301B. The first heat exchanger 301B in the cold pipeline 111 is directly immersed in the external natural cold source 501. The cold pipeline 111 exchanges heat with the external natural cold source 501 through this heat exchanger 301B. Another heat exchanger 301A in the cold pipeline 111 is connected to the heat exchanger 301X in the heat pipeline 104. The cold pipeline 111 exchanges heat with the heat pipelines 104 through these two connected heat exchangers 301A and 301X.

The use of 301X, 301A, and 301B is simply to distinguish between different heat exchangers and does not imply clear structural differences between them. They all apply to the concept of heat exchanger 301.

Optionally, any heat exchanger 301 (including 301X, 301A, 301B, etc.) can be distributed in multiple individual forms to enhance heat exchange efficiency with other heat exchangers 301 (including 301X, 301A, 301B, etc.).

Optionally, any heat exchanger 301 (including 301X, 301A, 301B, etc.) can be distributed in multiple individual forms to enhance heat exchange efficiency with low-temperature water bodies.

Optionally, the heat pipelines 104 and battery modules 103 are equipped with small heat exchangers to enhance heat exchange between the heat pipelines 104 and battery modules 103

Optionally, the types of heat exchangers 301 or small heat exchangers include: shell-and-tube heat exchangers, plate heat exchangers, finned heat exchangers, tube-in-tube heat exchangers, gas heat exchangers, condensers, evaporators, spiral plate heat exchangers, plate-fin heat exchangers, microchannel heat exchangers, heat pipe heat exchangers, tube heat exchangers, rotary heat exchangers, double-pipe plate heat exchangers, and phase-change heat exchangers.

Optionally, the cold pipelines 111 and/or heat pipelines 104 are deployed in multiple channels and connected to multiple heat exchangers 301 or small heat exchangers to enhance heat exchange efficiency.

Optionally, the small heat exchangers are distributed in multiple individual forms to enhance heat exchange efficiency with the battery modules 103.

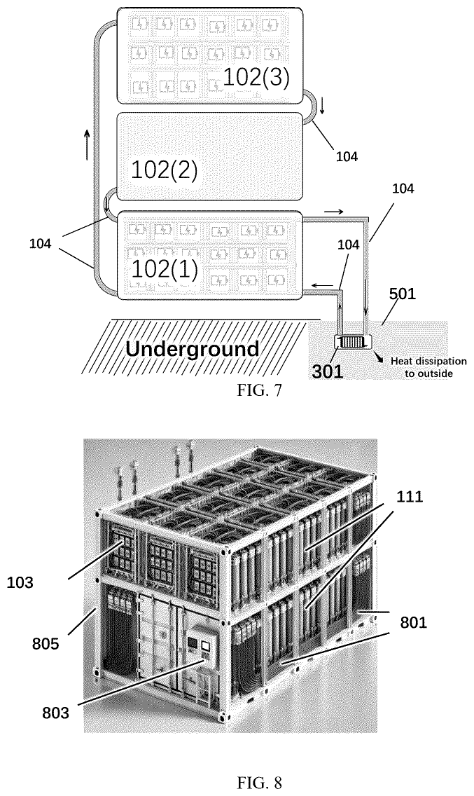

FIG. 7 is another schematic diagram of the low-temperature life-extension device for energy storage system adaptable to various natural cold source conditions according to an embodiment of the present invention.

Optionally, the energy storage cabinet modules 102 are arranged in a modular fashion, allowing the number of storage cabinet modules to be flexibly increased or decreased according to the needs, thus expanding the storage capacity.

That is, energy storage cabinet module 102(1), energy storage cabinet module 102(2), and energy storage cabinet module 102(3) are interconnected, enabling the low-temperature life-extension device to be flexibly modified based on conditions. In the figure, energy storage cabinet module 102(1), energy storage cabinet module 102(2), and energy storage cabinet module 102(3) are interconnected through the heat pipeline 104, and then the heat is exchanged through the heat exchanger 301 with the external natural cold source 501.

Optionally, the external natural cold sources 501 also include underground cavities, underground mines, geothermal heat exchange layers, glaciers, permafrost layers, forest surface coverage, high-altitude cold air resources, desert night radiation cooling resources, as well as caves, wind tunnels, or air passages formed by natural terrain. These natural cold sources can be selectively used according to the geographical conditions and climate characteristics of the energy storage station's location. Through reasonable heat exchange design and energy management systems, the cooling efficiency of the energy storage station can be further improved, achieving lifespan extension and energy-saving goals for the equipment under low-temperature environments. In this context, low-temperature water bodies can also be extended to include low-temperature gases, low-temperature gas-liquid mixtures, low-temperature liquid fluids (such as liquid nitrogen, liquefied air, etc.), low-temperature solid-liquid mixtures, low-temperature solid media (such as ice blocks, snow layers), and other low-temperature media with cooling effects. These low-temperature media can exchange heat with energy storage equipment through conduction, convection, or radiation.

It should be noted that the low-temperature life-extension device for energy storage system adaptable to various natural cold source conditions can be deployed on land, such as at lake shores, riverbanks, or coastlines; it can also be deployed at sea, for example, by constructing a floating platform on the sea to install battery storage devices, applying it directly to offshore oil drilling platforms, offshore wind power platforms, or large battery-powered ships. The deployment is primarily aimed at facilitating the use of external natural cold sources such as seawater, lake water, river water, estuarine water, groundwater, and spring water.

Optionally, the heat pipelines 104 are made of corrosion-resistant materials, suitable for various types of heat exchange fluids.

Optionally, the cold pipelines 111 are made of corrosion-resistant materials, suitable for various types of cooling fluids.

Optionally, the energy storage cabinet module 102 are made from corrosion-resistant materials, suitable for marine, high-salinity, or corrosive environments.

Optionally, the system further includes a wastewater treatment module for processing drainage generated during the cooling of low-temperature water bodies, preventing pollution or temperature anomalies from impacting the ecosystem. Optionally, the cooling fluid in the heat pipelines 104 dissipates heat through a natural flow process without the need for additional energy input. Optionally, the heat exchange fluid in the cold pipeline 111 dissipates heat through a natural flow process without the need for additional energy input. Optionally, the heat pipelines 104 are equipped with temperature sensors and/or small pumps, which can be used to adjust the flow rate of the cooling fluid. Optionally, the cold pipelines 111 are equipped with temperature sensors and/or small pumps, which can be used to adjust the flow rate of the heat exchange fluid.

Optionally, the energy storage cabinet modules 102 are also equipped with a real-time temperature control system that dynamically adjusts the flow rate or volume of the cooling fluid, maintaining the actual temperature of the battery modules 103 at the lifetime-extending temperature T. Optionally, the energy storage cabinet modules 102 are also equipped with a real-time temperature control system that dynamically adjusts the flow rate or volume of the heat exchange fluid, helping maintain the actual temperature of the battery modules 103 at the lifetime-extending temperature T.

Optionally, the real-time temperature control system can also monitor the temperatures of the cooling fluid, heat exchange fluid, individual battery modules 103, and individual heat exchangers 301, as well as the temperature differences between them, and use this information to make temperature adjustments.

Optionally, the lifetime-extending temperature T refers to a temperature value. By controlling the operating temperature of the battery modules 103 around the lifetime-extending temperature T, the cumulative service life of the battery modules 103 can be effectively extended. The steps to determine the lifetime-extending temperature T are as follows: First, based on the typical usage scenario of the target battery, select a temperature lower than the commonly recognized optimal working temperature in the industry as the lifetime-extending temperature T. Second, based on the usage environment of the target battery, determine the expected temperature variation range and set the average temperature within this range as the lifetime-extending temperature T.

The types of cumulative service life include cycle life, calendar life, cumulative discharge life, cumulative charge life, cumulative throughput life, cumulative mileage life, etc.

Cycle life refers to the number of charge and discharge cycles a battery can undergo before it fails or experiences significant performance degradation. With each charge and discharge cycle, the battery gradually loses some of its capacity. The cycle life refers to the number of complete charge and discharge cycles (usually expressed as charge-discharge cycles or charge-discharge cycle counts) that the battery can endure without significantly affecting its performance. Calendar life refers to the period from when the battery is first used until it fails or experiences significant performance degradation, typically measured in years. Even if the battery is not subjected to many charge and discharge cycles, its capacity and performance will gradually degrade over time due to chemical reactions, environmental factors (such as temperature and humidity), and storage conditions. In addition to these two common forms of life assessment, the battery's service life can be further refined based on different application scenarios and usage patterns.

The cumulative discharge capacity life refers to the total amount of energy discharged by the battery from the start of its use until it fails or experiences significant performance degradation. This focuses on the total energy provided by the battery, rather than just the number of charge-discharge cycles. The cumulative discharge capacity life provides a more comprehensive reflection of the battery's discharge performance under different operating conditions, and is typically used to assess the performance degradation of batteries under heavy load usage.

The cumulative charge capacity life refers to the total amount of energy charged into the battery from the start of its use until it fails or experiences significant performance degradation. It focuses on the total energy during the charging process, rather than the number of charging cycles. Similar to cumulative discharge capacity life, the cumulative charge capacity life helps assess the performance loss the battery may experience during the charging process.

The cumulative throughput life refers to the total charge and discharge amount from the start of the battery's use until it fails or experiences significant performance degradation, that is, the sum of the charging and discharging amounts. This index considers the overall energy input and output during the battery's life cycle and helps assess the battery's overall efficiency and durability.

Cumulative mileage life: For electric vehicles or similar applications, cumulative mileage life refers to the total mileage accumulated by the battery from the start of its use until it fails or experiences significant performance degradation. This index effectively reflects the battery's durability and its ability to maintain performance under high-intensity usage conditions.

In the battery life assessments mentioned above, it is worth emphasizing the impact of random incomplete charge and discharge cycles. In actual use, the battery often does not go through a complete charge-discharge cycle every time, but instead operates in a partial charge and discharge state. Such random incomplete charge-discharge cycles are common in everyday applications like electric vehicles, storage systems, or mobile devices, where the depth and frequency of charging and discharging are influenced by various load demands and usage habits. Although standard cycle life is usually defined based on complete charge and discharge cycles, the battery in real-world applications is often a combination of partial charge-discharge cycles. Therefore, indices such as cumulative discharge capacity, cumulative charge capacity, and cumulative throughput become particularly important in this context. Random incomplete charge and discharge cycles may cause the battery to degrade in performance with fewer cycles, especially if the charge or discharge depth is too large or small. Since the depth and frequency of charging and discharging vary, these incomplete cycles have different impacts on the battery's degradation pattern. Therefore, to evaluate battery performance, it is necessary to consider these real operating conditions rather than relying solely on ideal complete charge-discharge cycles. Under random incomplete charge and discharge cycles, indices like cumulative charge capacity, cumulative discharge capacity, cumulative throughput, and other life assessment indicators can more comprehensively reflect the battery's performance and degradation rate in actual usage environments.

Optionally, if it is not necessary to ensure that the surface or internal temperature of the battery modules remains constantly at the lifetime-extending temperature T, the real-time temperature control system can adjust the flow rate or volume of the heat exchange fluid or cooling fluid to maintain the temperature of the battery modules 103 within a temperature range T_range near the lifetime-extending temperature T.

Optionally, depending on the size, type, model, and parameters of the battery modules, the lifetime-extending temperature T can be any integer temperature between −50° C. and 50° C., or any integer temperature within a range of ±0.25° C., ±0.5° C., ±1° C. around the values between −50° C. and 50° C.;

Optionally, the temperature control measures can be used to adjust the surface or internal temperature of the battery modules to a specific temperature range T_range. Optionally, T_range can be specifically set based on fixed temperature sizes. Alternatively, the setting of T_range can also be set based on percentage.

Optionally, when water quality is poor or cooling performance diminishes, alternative measures can be taken to ensure the battery modules 103 maintain the lifetime-extending temperature T.

FIG. 8 is another schematic diagram of a low-temperature life-extension device for energy storage system adaptable to various natural cold source conditions according to one embodiment of the present invention, showing the cooperative relationship between various components, including power line 801, electrical control and monitoring system 802, container-type frame structure 803, battery module 103, and cold pipeline 111.

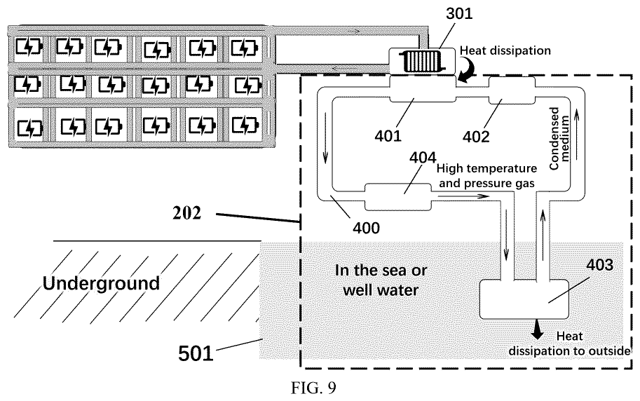

FIG. 9 is another schematic diagram of a low-temperature life-extension device for energy storage system adaptable to various natural cold source conditions according to one embodiment of the present invention.

Optionally, the low-temperature life-extension device further including alternative measures: a heat pump system. The heat pump system serves as internal-external heat exchange device 202 for auxiliary cooling and is activated only when cooling demand is high, preventing the battery modules from overheating and causing thermal runaway, thus avoiding the continuous high-energy consumption problems seen in traditional designs. The heat pump system includes an evaporator 401, condenser 403, compressor 404, and expansion valve 402. The evaporator 401 is connected to the internal-external heat exchange device 202, used to improve cooling efficiency when the cooling fluid flow is insufficient or cooling performance is poor.

Optionally, the heat pump system monitors the temperature of the battery modules 103 or individual heat exchangers 301 and automatically starts operating when the temperature difference exceeds a predetermined threshold, enhancing the cooling system's performance.

Optionally, the heat pump system includes an evaporator 401 and a heat pump pipeline 400. The evaporator 401 is placed on the heat pump pipeline 400, and the evaporator 401 is connected to the heat exchanger 301 in the heat pipelines 104. Refrigerant circulates through the heat pump pipeline 400. The cooling fluid in the heat pipelines 104 flows through the heat exchanger, it is cooled by the refrigerant in the evaporator 401. The refrigerant circulates through the heat pump pipeline 400 to dissipate heat.

Optionally, the heat pump pipeline 400 is sequentially connected to a compressor 404, condenser 403, expansion valve 402, and evaporator 401 along the circulation direction. The evaporator 401 is positioned between the expansion valve 402 and compressor 404. The condenser 403 uses stable low-temperature substances from the external natural cold source 501 to carry out the condensation process, exchanging heat from the refrigerant to the external natural cold source 501.

Optionally, the refrigerant used can be pure water or an organic medium. Optionally, the heat pump pipeline 400 is equipped with a small pump, which can adjust the flow rate of the refrigerant. Optionally, the energy storage cabinet modules 102 are also equipped with a real-time temperature control system, the real-time temperature control system can monitor the temperature of the battery modules 103 and dynamically adjust the flow rate or volume of the refrigerant to maintain the surface or internal temperature of the battery modules 103 at the lifetime-extending temperature T.

Optionally, if it is not strictly necessary to ensure that the surface or internal temperature of the battery modules 103 is always maintained at the lifetime-extending temperature T, the real-time temperature control system can adjust the flow rate or volume of the refrigerant to keep the surface or internal temperature of the battery modules 103 within the temperature range T_range, near the lifetime-extending temperature T.

Optionally, the low-temperature life-extension device can be provided with phase change materials (PCM) at specific positions as required, thereby “anchoring” the temperature of specific positions within a target temperature range.

Optionally, the phase change materials can be arranged at the junctions of different components of the low-temperature life-extension device, or coated on the outer surfaces of various components of the low-temperature life-extension device, or placed inside various components of the low-temperature life-extension device.

Optionally, the melting point of the phase change materials can be precisely adjusted through alloy formulation optimization or microcapsule encapsulation technology.

Optionally, the melting point of the phase change materials can be arbitrarily selected from the following values (non-exhaustive examples) and within ±2.5° C. of these values: 30° C., 25° C., 22.5° C., 20° C., 17.5° C., 15° C., 12.5° C., 10° C., 7.5° C., 5° C., 2.5° C., 0° C., −2.5° C., −5° C., −7.5 ° C., −10° C., −12.5° C., −15° C., −17.5° C., −20° C., −22.5° C., −25° C.

### Example 1

Application of the low-temperature life-extension device for energy storage system adaptable to various natural cold source conditions: In this embodiment, the energy storage system is located in a cold northern region, used for large-scale electricity storage and regulation. To extend the battery module's service life, the low-temperature life-extension device of this patent is adopted.

The energy storage system includes multiple energy storage cabinet modules, each energy storage cabinet module contains several battery modules. The battery modules are connected to the cooling system through the heat pipelines, and the cooling fluid circulates within the heat pipelines between the battery modules, effectively carrying away the heat generated during discharge. The heat pipelines'ends release the heat to the external natural cold source—lake water—via a heat exchanger.

In winter, the temperature of the lake water is relatively low, so the cooling fluid in the heat pipeline exchanges heat with the lake water through the heat exchanger, ensuring that the battery module stays in a stable low-temperature environment, thereby prolonging the battery's service life. The system is also equipped with internal-external heat exchange devices to ensure efficient heat exchange, even if water quality or flow changes slightly, maintaining effective cooling.

### Example 2

Energy storage system with Heat Pump-Assisted Cooling: In this embodiment, the energy storage system is located in an area with extreme climate, where the temperature fluctuates drastically and the cooling demand is high. To ensure stable operation of the battery modules in low-temperature conditions and further extend the battery's service life, a heat pump system is used as an auxiliary cooling device.

In this system, the heat pipelines exchange heat with an external natural cold source (such as underground water) via heat exchangers. In case the temperature of the external natural cold source is too low or fluctuates drastically, preventing sufficient cooling, the system automatically activates the heat pump system. The heat pump system enhances the cooling effect via a loop composed of an evaporator, compressor, and condenser, ensuring the battery module temperature stays within the optimal longevity range.

The real-time monitoring system enables the heat pump system to intelligently adjust the cooling fluid flow rate based on the temperature changes of the battery module, ensuring efficient operation even in cold environments while avoiding the energy waste issues faced by traditional cooling systems.

### Example 3

low-temperature life-extension device for energy storage system in a Marine Environment: This embodiment is suitable for energy storage system in marine environments. Due to the special properties and high salinity of seawater, the energy storage system adopts energy storage cabinet modules made of corrosion-resistant materials and ensures the equipment operates stably over the long term.

The energy storage cabinet modules are placed in areas near the coastline and use seawater as the external natural cold source. Through the internal-external heat exchange device, the cold pipeline exchanges heat with the cooling fluid in the heat pipelines, and the cold fluid in the cold pipeline passes through a filter before flowing into the heat exchanger, where it exchanges heat with the cooling fluid in the heat pipelines, finally releasing the heat produced by the battery module into the seawater.

This design fully utilizes the cooling advantages of seawater at low temperatures without adding extra energy consumption. The internal-external heat exchange device is designed to ensure that seawater does not cause contamination or corrosion to the cooling system, thereby extending the service life of the battery modules.

### Example 4

Modular Low-Temperature Longevity System for Energy storage systems: In this embodiment, the energy storage system adopts a modular design, where the number of energy storage cabinet modules can be flexibly increased or decreased to expand storage capacity as needed. Each energy storage cabinet module is equipped with heat pipelines and heat exchange devices to ensure each battery module is adequately cooled.

The cooling fluid inside the heat pipelines between the battery modules circulates naturally, carrying away the heat produced by the battery modules. At the ends of the heat pipelines, heat is released into external natural cold sources via heat exchangers. The use of multiple small heat exchangers in distributed contact with the battery modules significantly improves the heat exchange efficiency.

### Example 5

low-temperature life-extension device for energy storage system adaptable to various natural cold source conditions with remote monitoring system: In this embodiment, the energy storage system is located in a remote, cold region and is combined with a remote monitoring system to ensure the efficient operation of the low-temperature life-extension. The energy storage system includes multiple energy storage cabinet modules and a corresponding heat pipeline system, where the cooling fluid circulates and carries away the heat from the battery modules.

Each energy storage cabinet module is equipped with temperature sensors and flow rate control devices, which monitor the temperature of the battery modules and the flow rate of the cooling fluid in real-time. Through the remote monitoring system, operators can view the operational status, temperature, and flow rate data of each battery module at any time and adjust the flow rate or volume of the cooling fluid based on the data.

When the monitoring system detects that the battery module temperature exceeds the lifetime-extending temperature T, it automatically sends an alarm, and operators can use the remote control system to adjust the temperature control devices or activate backup cooling solutions. This avoids overheating due to human negligence or environmental changes, improving the battery module's service life.

### Example 6

low-temperature life-extension device for energy storage system adapted to extreme climate changes: in this embodiment, the energy storage system is located in an area with extreme climatic conditions, where the temperature fluctuates greatly between day and night. To accommodate these climate changes, the low-temperature life-extension device is equipped with a dual cooling system.

The energy storage cabinet modules are equipped with two cooling modes: one is the conventional heat pipeline system, which exchanges heat with external natural cold sources (such as river water) through the cooling fluid in the heat pipelines. The other mode is an auxiliary heat pump system that automatically activates when the temperature of the external cooling source is too high or fluctuates drastically, ensuring stable cooling performance.

In addition, the system is equipped with multiple temperature control mechanisms, which automatically select the appropriate cooling method based on the climate conditions. Temperature sensors continuously monitor the battery module temperature, and when the external temperature fluctuates drastically, the system switches to the heat pump mode to ensure that the battery module remains within a range around the lifetime-extending temperature T.

### Example 7

Integrated Optimization of low-temperature life-extension device for energy storage system adaptable to various natural cold source conditions with remote monitoring system: In this embodiment, the energy storage system uses a large-scale integrated low-temperature life-extension device suitable for urban grid load regulation needs. The battery storage system adopts a modular design, and multiple energy storage cabinet modules are connected through heat pipelines and cooling fluid systems for efficient heat exchange.

To improve the system's operating efficiency, each energy storage cabinet module is equipped with multiple small heat exchangers distributed around the battery modules. These heat exchangers significantly enhance the heat exchange efficiency. Meanwhile, the cooling fluid is distributed through multi-channel pipes, ensuring that each battery module's heat is fully dissipated, preventing temperature concentration that could impact the system's stability.

### Example 8

Comprehensive Temperature Control System for Low-temperature life-extension device in a Energy storage system in a Low-Temperature Environment: In this embodiment, the energy storage system is located in a cold mountainous region, where the battery modules need to operate stably in low-temperature environments for extended periods. To achieve this, the system adopts an advanced integrated temperature control system, which includes heat pipelines, internal-external heat exchange devices, real-time temperature control modules, and small pumps.

The heat pipelines carry the heat away from the battery modules through circulating cooling fluid, and the heat exchangers transfer the heat to the external natural cold sources such as mountain stream water or snowmelt. The integrated temperature control system adjusts the cooling fluid flow rate in real-time based on the battery module's temperature, ensuring that the temperature remains within a range around the lifetime-extending temperature T.

### Example 9

Low-temperature life-extension device for a Deep-Sea Energy storage system: In this embodiment, the energy storage system is deployed in the deep-sea area, far from the coast. Deep-water cooling technology is used. The energy storage cabinet modules are made of corrosion-resistant materials to withstand the high pressure and salinity of the deep-sea environment.

The heat pipelines of the battery modules directly exchange heat with the seawater. The heat exchangers are connected to the deep-sea low-temperature water through the cold pipelines. Deep-sea water has a relatively stable temperature, continuously providing a low-temperature environment to help maintain the battery modules within a range around the lifetime-extending temperature T. In addition, to optimize heat exchange efficiency, the cold pipelines are equipped with multiple heat exchangers to increase the contact area between seawater and the heat exchange fluid, improving heat exchange performance.

To ensure long-term stable operation of the system, it is equipped with real-time monitoring and automatic adjustment mechanisms. These mechanisms monitor changes in seawater temperature and battery module temperature. When the temperature deviates from the set range, the system automatically adjusts the cooling fluid flow rate or activates auxiliary equipment for regulation.

### Example 10

low-temperature life-extension device for energy storage system with Convenient Maintenance and Efficient Cooling: In this embodiment, the energy storage system is located in a sparsely populated area, where maintenance is challenging. Therefore, the system adopts a modular design with easily replaceable internal-external heat exchange devices to facilitate regular maintenance and component replacement. The cooling liquid system in each energy storage cabinet module can be separately disassembled, cleaned, or replaced.

The internal-external heat exchange devices are designed as detachable structures, making it convenient to clean the pipes and replace damaged components. This design prevents efficiency reduction caused by dirt accumulation or component aging. In addition, the filters in the cold pipelines can be periodically replaced to ensure the cleanliness of the cooling fluid and keep the system running at optimal performance.

The system is also equipped with a backup heat exchange fluid circulation path. When the main cooling system fails, the system can automatically switch to the backup system to ensure that the battery module maintains the low-temperature longevity effect under any circumstances.

These examples further demonstrate the optimization and application of the low-temperature life-extension device in different environmental conditions, solving the issues of long-term stability and efficient operation of battery storage systems under extreme temperature environments, covering various scenarios from extreme climates to efficient maintenance.

The low-temperature life-extension device for the energy storage system of this invention can be equipped with additional auxiliary devices based on specific application needs to enhance the system's adaptability, stability, and operational efficiency.

### Auxiliary Example 1

Temperature and Humidity Sensor System: This system can monitor the temperature and humidity changes inside and outside the energy storage cabinet module in real-time, ensuring that the equipment operates optimally in humid or fluctuating temperature environments, thereby extending the battery module's service life and improving its efficiency.

Key Design of this Example: Sensor Arrangement: Temperature and humidity sensors are installed inside and outside the energy storage cabinet module to accurately monitor the battery module's working environment. Automatic Adjustment System: The system automatically adjusts the cooling system based on real-time temperature and humidity data, ensuring the energy storage cabinet module stays within the optimal temperature and humidity range, preventing condensation or battery overheating. Data Feedback and Remote Monitoring: All sensor data is transmitted to a central control system and provided to a remote monitoring platform via wireless connection, allowing staff to view and manage the battery module's operating environment at any time.

### Auxiliary Example 2

Automatic Cleaning System: This system can periodically clean the cooling pipes and heat exchangers, preventing the accumulation of scale and impurities, ensuring that the heat exchange efficiency is not affected, and extending the system's service life while reducing maintenance workload.

Key Design of this Example: Cleaning Mechanism: The automatic cleaning system consists of circulating water flow and brushing devices that periodically wash the heat exchangers and water pipes, removing sediment and debris. Intelligent Adjustment: The system monitors water flow speed and cooling efficiency in real-time and automatically starts the cleaning procedure when necessary, ensuring that the heat exchangers and pipes remain clean. Cleaning Method: The cleaning is carried out through the natural movement of water and the automatic brushing and flushing of the pipes, keeping the heat exchangers and pipes in good working condition.

### Auxiliary Example 3

Pressure and Flow Monitoring System: The pressure and flow monitoring system monitors the cooling water flow and pressure in real-time, effectively preventing pipe blockages or abnormal water flow, ensuring stable cooling efficiency, and providing continuous and stable temperature control for the battery modules.

Key Design of this Example: Pressure Sensors: Pressure sensors are installed at key pipeline locations in the cooling system to monitor the water flow pressure changes in real-time. Flow Meters: Flow meters monitor the cooling water flow to ensure it remains within the preset range, guaranteeing cooling performance. Intelligent Feedback Mechanism: When the system detects abnormal pressure or flow, it automatically adjusts the pump speed or changes the water flow path to optimize cooling efficiency.

### Auxiliary Example 4

Intelligent Data Collection and Remote Monitoring System: The intelligent data collection and remote monitoring system can collect device operating data in real-time and monitor it via a remote platform, ensuring that staff can timely grasp the device status, provide early warnings for potential failures, and remotely adjust settings, thereby improving operation and maintenance efficiency and reducing manual intervention.

Key Design of this Example: Data Collection Module: The system collects real-time data on battery voltage, temperature, and cooling water flow speed. Remote Monitoring Platform: All collected data is transmitted wirelessly to a cloud platform, where staff can monitor and adjust the device status remotely. Fault Warning Function: When the system operation exceeds preset parameters, it automatically sends an alarm signal to the control center, allowing staff to respond immediately.

### Auxiliary Example 5

Backup Battery Power Supply System: The backup battery power supply system provides backup power support in case of an external power failure, ensuring that the temperature control system, data collection system, and other key equipment continue to operate, preventing equipment failure or downtime due to power issues.

Key Design of this Example: Backup Battery Pack: High-performance batteries are configured to provide sufficient power support when the main power supply is interrupted. Automatic Switching Function: When the main power supply fails, the system automatically switches to the backup battery power supply to ensure that the temperature control system and data collection system continue to operate. Charging Management: The backup battery is integrated with the main power supply system to ensure that it charges automatically during normal operation.

### Auxiliary Example 6

Heat Recovery System: The heat recovery system recycles excess heat from the cooling water, effectively transferring the thermal energy to other areas for heating needs, reducing energy consumption, and further improving the overall energy efficiency of the system.

Key Design of this Example: Heat Exchanger: The heat recovery system uses a heat exchanger to transfer the heat from the cooling water to the water or air system that needs heating. Circulatory System: The internal pipeline system effectively transports heat, optimizing energy usage. Automated Control: The heat recovery intensity is automatically adjusted based on demand, ensuring the coordinated operation of both the cooling system and heat recovery system.

### Auxiliary Example 7

Environmental Monitoring and Alarm System: The environmental monitoring and alarm system continuously monitors external environmental parameters (such as temperature, humidity, wind speed, etc.) and triggers alarms and automatic adjustment measures, such as activating the heat pump or adjusting wind speed, in response to environmental abnormalities to ensure the energy storage station operates safely and stably.

Key Design of this Example: Environmental Sensors: A variety of sensors are placed to monitor external environmental parameters in real-time. Alarm Mechanism: When external environmental parameters exceed the set range, the alarm system is activated automatically. Automatic Adjustment Function: The system adjusts the equipment operating state based on alarm information, such as activating the heat pump or adjusting the wind speed.

### Auxiliary Example 8

Anti-Freezing Protection Device: In cold environments, the anti-freezing protection device prevents the cooling pipes and battery modules from freezing due to low temperatures by using heating devices, ensuring that the equipment can operate normally in extremely low-temperature conditions.

Key Design of this Example: Heating Device: Electric heating devices are installed around the cooling pipes and battery modules to prevent freezing. Temperature Control System: The temperature control system monitors the environmental temperature in real-time and automatically activates the heating device when the temperature drops below 0° C. Intelligent Control: The heating intensity is adjusted based on actual demand, avoiding overheating or energy wastage.

### Auxiliary Example 9

Water Quality Monitoring System: The water quality monitoring system continuously detects parameters such as pH, conductivity, and turbidity of the cooling water, ensuring that the cooling water remains free from contamination or changes over time, avoiding scaling, corrosion, and other issues that could impact the heat exchangers, battery modules, and cooling systems. The system can automatically adjust the filter or initiate periodic cleaning, effectively improving cooling system efficiency and extending equipment service life.

Key Design of this Example: Water Quality Sensors: Various water quality sensors (such as pH, temperature, conductivity, turbidity, etc.) are installed to monitor the cooling water's quality in real-time. Water Quality Data Feedback: The water quality data is transmitted to the central control system in real-time. The system automatically adjusts the filter's operation or activates the water quality cleaning function based on the real-time data. Automated Adjustment: The system automatically adjusts filtration and water quality improvement measures based on the monitoring results to ensure that the water quality meets operational requirements.

### Auxiliary Example 10

Automatic Drainage System: The automatic drainage system monitors the water level changes inside the energy storage cabinet module in real-time, ensuring that when there is water accumulation or abnormal water quality, it can drain the water promptly, preventing cooling water from stagnating and causing system failure or performance degradation. The system is linked to the water quality monitoring system and will automatically switch to a backup water source when the water quality is unsatisfactory, ensuring that the system remains in optimal operating condition, reducing maintenance workload and improving equipment reliability.

Key Design of this Example: Water Level Sensors: Water level sensors are installed inside the energy storage cabinet module to monitor water level changes in real-time. Automatic Drainage Valve: The system automatically controls the drainage valve to release accumulated water based on the water level sensor's feedback, ensuring that cooling water does not stagnate inside the energy storage cabinet module. Linked with Water Quality Monitoring System: When water quality anomalies are detected, the system automatically drains unqualified water and switches to a backup water source.

### Auxiliary Example 11

Wind-Assisted Cooling System: The wind-assisted cooling system enhances cooling efficiency by installing wind turbines or fans outside the energy storage cabinet modules. The system accelerates the evaporation of cooling water or improves air circulation, especially during high external temperatures. The system can automatically adjust the wind power equipment's operation through an intelligent control system, ensuring maximum energy utilization.

Key Design of this Example: Wind Turbines: Wind turbines or fans are installed outside the energy storage cabinet modules to increase air movement and assist with cooling. Intelligent Control System: The wind equipment is connected to the cooling system, and its operation speed is automatically adjusted by an intelligent control system, ensuring the best usage based on environmental demands. Airflow Guiding: Effective airflow guiding devices are designed to ensure the wind power equipment maximizes its cooling effect and reduces the burden on cooling water evaporation.

### Auxiliary Example 12

Energy Efficiency Monitoring and Optimization System: The energy efficiency monitoring and optimization system monitors the energy consumption of the energy storage station in real-time. By installing temperature, power, and current sensors, the system can analyze and automatically adjust the cooling system's operational status, optimizing operational efficiency and ensuring that the system provides optimal cooling effects with minimal energy consumption. This system helps reduce energy consumption, enhances system economy, and supports sustainable environmental goals.

Key Design of this Example: Energy Efficiency Monitoring Module: The system installs sensors for current, power, temperature, and other parameters to monitor the cooling system's energy consumption in real-time. Intelligent Optimization Algorithm: Based on the battery module's status and environmental conditions, the system automatically optimizes the cooling system's working parameters (such as pump flow speed and cooling temperature) to achieve the best cooling effect with minimal energy consumption. Energy Management Platform: The energy efficiency data is displayed on a cloud platform, and staff can monitor and adjust the system's efficiency remotely in real-time.

The above-mentioned examples of the low-temperature life-extension device for energy storage system adaptable to various natural cold source conditions can be distributed across different functional modules based on specific needs, to complete all or part of the functions described above. This division of internal structures into different functional modules is not restrictive.

The examples provided in this specification describe the principles and advantages of the present invention in a progressive manner, with each example highlighting differences from others. The same or similar parts across examples are referenced, ensuring clarity.

The above examples illustrate the principles and effectiveness of the invention and are not intended to limit the invention. Any person skilled in the art may modify or change the above examples without deviating from the spirit and scope of the invention. Therefore, any equivalent modifications or changes made by a person with ordinary skill in the art without departing from the spirit and technical ideas of the present invention should be covered by the claims of this invention.

It should be noted that, for those skilled in the art, various improvements and modifications can be made to this application without deviating from the original principles of the invention. These improvements and modifications also fall within the scope of the claims of this application.

This solution allows for the connection of the pipeline to external low-temperature environments without requiring the energy storage system itself to be exposed to the low-temperature environment. This makes the solution more easily integrated and modified with existing equipment. For example, existing energy storage systems can easily be modified through simple technical adjustments to utilize external natural cold sources for cooling, without the need to rebuild subsea facilities, reducing the overall technical difficulty and economic burden.

The proposed pipeline introduction of external natural cold sources for energy storage station cooling, compared to traditional energy storage systems and subsea energy storage systems, has significant innovation and cost advantages. By placing the energy storage system on land rather than directly on the seabed, it avoids the pressure of seawater on the equipment, drastically reducing the cost and complexity of construction, and making it easy to modify and maintain existing equipment. At the same time, this solution not only offers high cost-efficiency but also extends battery lifespan, improving the long-term reliability and economic efficiency of the energy storage system. Therefore, this solution holds great practical significance in terms of cost savings, benefit enhancement, and sustainable development, and is expected to have a profound impact on the energy storage field.

1. A low-temperature life-extension device for energy storage system adaptable to various natural cold source conditions, including:
Energy storage cabinet module, battery modules, heat pipelines, and external natural cold sources;
The energy storage cabinet module contains multiple battery modules; the battery modules are responsible for storing and releasing electrical energy and are the fundamental units and core components of the energy storage cabinet module;
The heat pipelines are arranged in a winding manner between the battery modules;
The heat pipelines contain circulating cooling fluid inside; The cooling fluid can exchange heat with the battery modules;
The battery modules adopt passive heat dissipation designs, allowing heat transfer through the heat pipelines to exchange heat with the external natural cold sources;
The external natural cold sources include seawater, lake water, river water, groundwater, spring water, and other low-temperature water bodies, which are widespread and maintain relatively stable temperatures.

2. The low-temperature life-extension device for energy storage system adaptable to various natural cold source conditions according to the preceding claim, characterized by:
The end of the heat pipelines are equipped with a heat exchanger;
The heat exchanger at the end of the heat pipelines can be directly placed into the external natural cold source, and the heat pipelines exchanges heat with the external natural cold source through the heat exchanger;
The cooling fluid exchanges heat with the battery modules through the walls of the heat pipelines as a medium;
The battery modules exist as individual batteries, or are assembled from multiple battery cells in series or parallel, or are combined through reasonable arrangements of multiple battery units or battery packs into larger battery clusters;
The low temperature life-extension device can be provided with phase change materials (PCM) at specific positions as required, thereby “anchoring” the temperature of specific positions within a target temperature range.

3. The low-temperature life-extension device for energy storage system adaptable to various natural cold source conditions according to claim 2, characterized by:
The phase change materials can be arranged at the junctions of different components of the low-temperature life-extension device, or coated on the outer surfaces of various components of the low-temperature life-extension device, or placed inside various components of the low-temperature life-extension device;
Further including an internal-external heat exchange device;
The internal-external heat exchange device serves as the overall medium for heat exchange, enabling heat transfer between the heat pipelines and the external natural cold source;
The internal-external heat exchange device includes a cold pipeline, through which the external natural cold source can flow directly;
The cold pipeline shares the same heat exchanger with the heat pipelines, and the cold pipeline exchanges heat with the heat pipelines through the heat exchanger;
The cold pipeline in the internal-external heat exchange device is equipped with a filter to remove debris or suspended particles within the cold pipeline.

4. The low-temperature life-extension device for energy storage system adaptable to various natural cold source conditions according to claim 3, characterized by:
The internal-external heat exchange device includes a structure where the cold pipeline is closed and circulates heat exchange fluid;
The structure of the internal-external heat exchange device further includes a heat exchanger; specifically, the cold pipeline shares the same heat exchanger with the heat pipelines, and the cold pipeline exchanges heat with the heat pipelines through this heat exchanger; The cold pipeline is also equipped with another heat exchanger and is directly placed in the external natural cold source, allowing the cold pipeline to exchange heat with the external natural cold source through this heat exchanger;
The structure of the internal-external heat exchange device further includes a heat exchanger; specifically, the cold pipeline has two heat exchangers; The first heat exchanger in the cold pipeline is directly placed in the external natural cold source, and the cold pipeline exchanges heat with the external natural cold source through this heat exchanger; Another heat exchanger in the cold pipeline is connected to the heat exchanger in the heat pipelines, and the cold pipeline exchanges heat with the heat pipelines through both heat exchangers;
The cooling fluid can be pure water, organic medium, or low-temperature water body from the external natural cold source; the heat exchange fluid can also be pure water, organic medium, or low-temperature water body from the external natural cold source.

5. The low-temperature life-extension device for energy storage system adaptable to various natural cold source conditions according to claim 4, characterized by:
Any heat exchanger can be distributed in multiple individual forms to enhance heat exchange efficiency with other heat exchangers;
Any heat exchanger can be distributed in multiple individual forms to enhance heat exchange efficiency with low-temperature water bodies;
The heat pipelines and battery modules are equipped with small heat exchangers to enhance heat exchange between the heat pipelines and battery modules;
The small heat exchangers are distributed in multiple individual forms to enhance heat exchange efficiency with the battery modules;
The cold pipelines and/or heat pipelines are deployed in multiple channels and connected to multiple heat exchangers or small heat exchangers to enhance heat exchange efficiency;
The energy storage cabinet modules are arranged in a modular fashion, allowing the number of storage cabinet modules to be flexibly increased or decreased according to the needs, thus expanding the storage capacity.

6. The low-temperature life-extension device for energy storage system adaptable to various natural cold source conditions according to claim 5, characterized by:
The heat pipelines are made of corrosion-resistant materials, suitable for various types of heat exchange fluids;
The cold pipelines are made of corrosion-resistant materials, suitable for various types of cooling fluids;
The energy storage cabinet modules are made from corrosion-resistant materials, suitable for marine, high-salinity, or corrosive environments;
The energy storage cabinet modules are placed near the external natural cold source to facilitate heat dissipation using the external natural cold source;
The cooling fluid in the heat pipelines dissipates heat through natural flow without the need for additional energy input;
The heat exchange fluid in the cold pipeline dissipates heat through natural flow without the need for additional energy input.

7. The low-temperature life-extension device for energy storage system adaptable to various natural cold source conditions according to claim 6, characterized by:
The types of heat exchangers or small heat exchangers include: shell-and-tube heat exchangers, plate heat exchangers, finned heat exchangers, tube-in-tube heat exchangers, gas heat exchangers, condensers, evaporators, spiral plate heat exchangers, plate-fin heat exchangers, microchannel heat exchangers, heat pipe heat exchangers, tube heat exchangers, rotary heat exchangers, double-pipe heat exchangers, and phase-change heat exchangers;
The external natural cold sources also include underground cavities, underground mines, geothermal heat exchange layers, glaciers, permafrost layers, forest surface coverage, high-altitude cold air resources, desert night radiation cooling resources, as well as caves, wind tunnels, or air passages formed by natural terrain;
Further including a wastewater treatment module for processing drainage generated during the cooling of low-temperature water bodies, preventing pollution or temperature anomalies from impacting the ecosystem.

8. The low-temperature life-extension device for energy storage system adaptable to various natural cold source conditions according to claim 7, characterized by:
The heat pipelines are equipped with temperature sensors and/or small pumps, which can be used to adjust the flow rate of the cooling fluid;
The cold pipelines are equipped with temperature sensors and/or small pumps, which can be used to adjust the flow rate of the heat exchange fluid;
The energy storage cabinet modules are also equipped with a real-time temperature control system that dynamically adjusts the flow rate or volume of the cooling fluid, maintaining the actual temperature of the battery modules at the lifetime-extending temperature T;
The energy storage cabinet modules are also equipped with a real-time temperature control system that dynamically adjusts the flow rate or volume of the heat exchange fluid, helping maintain the actual temperature of the battery modules at the lifetime-extending temperature T;
The real-time temperature control system can also monitor the temperatures of the cooling fluid, heat exchange fluid, individual battery modules, and individual heat exchangers, as well as the temperature differences between them, and use this information to make temperature adjustments.

9. The low-temperature life-extension device for energy storage system adaptable to various natural cold source conditions according to claim 8, characterized by:
The lifetime-extending temperature T refers to a temperature value; By controlling the operating temperature of the battery modules around the lifetime-extending temperature T, the cumulative service life of the battery modules can be effectively extended; The steps to determine the lifetime-extending temperature T are as follows: First, based on the typical usage scenario of the target battery, select a temperature lower than the commonly recognized optimal working temperature in the industry as the lifetime-extending temperature T; Second, based on the usage environment of the target battery, determine the expected temperature variation range and set the average temperature within this range as the lifetime-extending temperature T;
If it is not necessary to ensure that the surface or internal temperature of the battery modules remains constantly at the lifetime-extending temperature T, the real-time temperature control system can adjust the flow rate or volume of the heat exchange fluid or cooling fluid to maintain the temperature of the battery modules within a temperature range T_range near the lifetime-extending temperature T;
Depending on the size, type, model, and parameters of the battery modules, the lifetime-extending temperature T can be any integer temperature between −50° C. and 50° C. or any integer temperature within a range of ±0.25° C., ±0.5° C., ±1° C. around the values between −50° C. and 50° C.;
The temperature control measures can be used to adjust the surface or internal temperature of the battery modules to a specific temperature range T_range, with the upper and lower limits of the T_range selected from one of the following values: 50° C., 45° C., 40° C., 35° C., 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C.;
T_range can be specifically set based on fixed temperature sizes, specifically, setting the temperature range to ±0.001° C., ±0.002° C., ±0.004° C., ±0.008° C., ±0.016° C., ±0.032° C., ±0.064° C., ±0.128° C., ±0.256° C., ±0.512° C., ±1° C., ±2° C., ±4° C., ±8° C., ±16° C., ±32° C., ±64° C., ±128° C., ±256° C., ±512° C., relative to the lifetime-extending temperature T;
T_range can also be set based on percentage, specifically setting the temperature range to ±0.001%, ±0.002%, ±0.004%, ±0.008%, ±0.016%, ±0.032%, ±0.064%, ±0.128%, ±0.256%, ±0.512%, ±1%, ±2%, ±4%, ±8%, ±16%, ±32%, ±64%, ±128%, ±256%, ±512% relative to the lifetime-extending temperature T;
The melting point of the phase change materials can be precisely adjusted through alloy formulation optimization or microcapsule encapsulation technology;
The melting point of the phase change materials can be arbitrarily selected from the following values (non-exhaustive examples) and within ±2.5° C., of these values: 30° C., 25° C., 22.5° C., 20° C., 17.5° C., 15° C., 12.5° C., 10° C., 7.5° C., 5° C., 2.5° C., 0° C., −2.5° C., −5° C., −7.5° C., −10° C., −12.5° C., −15° C., −17.5° C., −20° C., −22.5° C., −25° C.

10. The low-temperature life-extension device for energy storage system adaptable to various natural cold source conditions according to claim 9, characterized by:
When water quality is poor or cooling performance diminishes, alternative measures can be taken to ensure the battery modules maintain the lifetime-extending temperature T;
Further including alternative measures: a heat pump system; The heat pump system serves as internal-external heat exchange device for auxiliary cooling and is activated only when cooling demand is high, preventing the battery modules from overheating and causing thermal runaway, thus avoiding the continuous high-energy consumption problems seen in traditional designs; The heat pump system includes an evaporator, condenser, compressor, and expansion valve; The evaporator is connected to the internal-external heat exchange device, used to improve cooling efficiency when the cooling fluid flow is insufficient or cooling performance is poor;
The heat pump system monitors the temperature of the battery modules or individual heat exchangers and automatically starts operating when the temperature difference exceeds a predetermined threshold, enhancing the cooling system's performance;
The heat pump system includes an evaporator and heat pump pipeline; The evaporator is placed on the heat pump pipeline, and the evaporator is connected to the heat exchanger in the heat pipelines; Refrigerant circulates through the heat pump pipeline; The cooling fluid in the heat pipelines flows through the heat exchanger, it is cooled by the refrigerant in the evaporator; The refrigerant circulates through the heat pump pipeline to dissipate heat;
The heat pump pipeline is sequentially connected to a compressor, condenser, expansion valve, and evaporator along the circulation direction; The evaporator is positioned between the expansion valve and compressor; The condenser uses stable low-temperature substances from the external natural cold source to carry out the condensation process, exchanging heat from the refrigerant to the external natural cold source;
The refrigerant used can be pure water or an organic medium;
The heat pump pipeline is equipped with a small pump, which can adjust the flow rate of the refrigerant;
The energy storage cabinet modules are also equipped with a real-time temperature control system, the real-time temperature control system can monitor the temperature of the battery modules and dynamically adjust the flow rate or volume of the refrigerant to maintain the surface or internal temperature of the battery modules at the lifetime-extending temperature T;
If it is not strictly necessary to ensure that the surface or internal temperature of the battery modules is always maintained at the lifetime-extending temperature T, the real-time temperature control system can adjust the flow rate or volume of the refrigerant to keep the surface or internal temperature of the battery modules within the temperature range T_range, near the lifetime-extending temperature T.
